(19) United States
(12) Patent Application Publication
(10) Pub. No.: US 2025/0171602 A1
(43) Pub. Date: May 29, 2025

(54) HIGH HEAT-RESISTANT CARBON NANOSTRUCTURE POLYMER COMPOSITE AND HYBRID COMPOSITE INCLUDING THE SAME

(71) Applicant: KOREA INSTITUTE OF MATERIALS SCIENCE, Changwon-si (KR)

(72) Inventors: Youngseok OH, Gimhae-si (KR); Byeongho PARK, Changwon-si (KR); Jungwan LEE, Changwon-si (KR); Moon-Kwang UM, Changwon-si (KR); Jin-Woo YI, Changwon-si (KR); Hyekyeong JANG, Changwon-si (KR); Taehoon KIM, Seoul (KR)

(21) Appl. No.: 18/938,434

(22) Filed: Nov. 6, 2024

(30) Foreign Application Priority Data
Nov. 27, 2023 (KR) 10-2023-0167292
Jul. 22, 2024 (KR) 10-2024-0096672

(51) Int. Cl. C08J 5/24; B29C 70/02; B29C 70/26; B29K 63/00; B29K 101/10; B29K 307/04; C08J 9/00; C08J 9/28; C08K 3/04

(52) U.S. Cl. CPC C08J 5/249; B29C 70/021; B29C 70/26; C08J 5/243; C08J 9/008; C08J 9/283; C08K 3/041; B29K 2063/00; B29K 2101/10; B29K 2307/04; C08J 2201/0504; C08J 2205/026; C08J 2363/00; C08K 2201/011

(57) ABSTRACT

The present invention relates to a high heat-resistant carbon nanostructure polymer composite, and further relates to a hybrid composite including carbon fibers (CF) using the high heat-resistant carbon nanostructure polymer composite. More specifically, the present invention relates to the hybrid composite having a stack structure in which a carbon fiber layer and an intermediate material layer are stacked on top of each other, wherein the intermediate material layer has a stack structure of a high heat-resistant carbon nanostructure polymer composite and a polymer. The hybrid composite has secured thermal stability and thus may be used for actual applications.

### CROSS-REFERENCE TO RELATED APPLICATIONS

This application claims benefit and priority to Korean Patent Application No. 10-2023-0167292, filed on Nov. 27, 2023, and Korean Patent Application No. 10-2024-0096672, filed on Jul. 22, 2024, with the Korean Intellectual Property Office, the disclosure of which is incorporated herein in its entirety by reference.

### BACKGROUND

### Field

The present disclosure relates to a high heat-resistant carbon nanostructure polymer composite, and further relates to a hybrid composite including carbon fibers (CF) using the high heat-resistant carbon nanostructure polymer composite. In particular, the present disclosure relates to the hybrid composite having a stack structure in which a carbon fiber layer and an intermediate material layer are stacked on top of each other, wherein the intermediate material layer has a stack structure of a high heat-resistant carbon nanostructure polymer composite and a polymer.

### Description of Related Art

A conventional polymer matrix-based carbon composite has low density and excellent mechanical properties compared to a conventional metal-based carbon composite material and thus has been widely applied for the weight reduction of various transportation devices such as aircraft, automobiles, and ships. Due to these characteristics, the polymer matrix-based carbon composite plays an important role in increasing energy efficiency, improving performance, and reducing environmental impact.

However, it is pointed out that the polymer matrix-based carbon composite has a relatively low working temperature compared to a metal material due to the inherent thermal properties of the polymer matrix thereof. The low thermal stability of the polymer matrix is a major factor that limits the application of the polymer matrix-based carbon composite especially to high-temperature environments. Thus, the polymer matrix-based carbon composite is not applied to a part that operates at high temperatures, such as parts in in the aerospace and automotive industries.

In particular, the carbon composite based on the polymer matrix has a lower glass transition temperature (Tg) than the metal material. Thus, an application temperature range thereof is limited. The glass transition temperature refers to a temperature at which a polymer material transitions from a glassy state to a rubbery state. Below this Tg temperature, the material is hard and strong, while above this Tg temperature, the material becomes flexible and easily deformed. Therefore, the polymer matrix-based carbon composite with a low glass transition temperature has difficulty in maintaining mechanical strength and dimensional stability at high temperatures.

### SUMMARY

In order to solve the above problem, the present disclosure proposes various approaches and technologies to improve the heat resistance of the polymer matrix-based carbon composite to a heat resistance of a metal.

A purpose of the present disclosure is to enable the polymer matrix-based carbon composite to exhibit heat resistance performance equivalent to or higher than that of the metal material. However, in order to achieve this purpose, many challenges remain, and multifaceted research and development are required, such as structural modification of the polymer matrix, optimization of additives, and improvement of the preparation process. These studies will ultimately contribute to expanding the scope of application of the polymer matrix-based carbon composite, and developing innovative materials that may operate stably even in high-temperature environments.

Thus, a purpose of the present disclosure is to provide a high heat-resistant carbon nanostructure polymer composite with an improved glass transition temperature.

Furthermore, a purpose of the present disclosure is to provide a hybrid composite having a stack structure in which a carbon fiber layer and an intermediate material layer are stacked on top of each other, wherein the intermediate material layer has a stack structure of the high heat-resistant carbon nanostructure polymer composite with an improved glass transition temperature and a polymer.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A first aspect of the present disclosure provides a high heat-resistant carbon nanostructure polymer composite comprising: a nanocage structure composed of carbon nanostructure aerogels; and a thermosetting crosslinked polymer positioned in inner pores of the nanocage structure.

In accordance with some embodiments of the first aspect, a minimum length by which the polymer positioned in the inner pores of the nanocage structure can move under a glass transition temperature is smaller than a minimum length by which the polymer itself can move under the glass transition temperature, such that a following Equation 1 is satisfied:

$$ζ < {ζ}_{Bulk polymer} \qquad [ Equation 1 ]$$

where ζ denotes a minimum length by which a thermosetting resin can move in the composite under the glass transition temperature or a size of a space in the nanocage structure where the crosslinked polymer is able to be present, and ζ_{Bulk polymer} denotes a minimum length by which the crosslinked polymer itself can move under the glass transition temperature.

In accordance with some embodiments of the first aspect, a correlation between a distance between the carbon nanostructure aerogels in a polymer matrix and a volume fraction of the carbon nanostructure aerogel in the high heat-resistant carbon nanostructure polymer composite is expressed based on a following Equation 2:

$$\frac{Δ}{R} = \sqrt{\frac{{V}_{f , max}}{{V}_{f}}} - 1 \qquad [ Equation 2 ]$$

wherein in the Equation 2, 2Δ denotes a distance between nanotubes in the carbon nanostructure aerogel, R denotes a radius of each of the nanotubes constituting the carbon nanostructure aerogel, V_{f,max} denotes a maximum volume fraction of the carbon nanostructure aerogel, and V_{f} denotes a volume fraction of the carbon nanostructure aerogel.

In accordance with some embodiments of the first aspect, a content of the carbon nanostructure aerogel in the high heat-resistant carbon nanostructure polymer composite is 10 vol % or greater.

In accordance with some embodiments of the first aspect, a content of the carbon nanostructure aerogel in the high heat-resistant carbon nanostructure polymer composite is 20 vol % or greater.

In accordance with some embodiments of the first aspect, a content of the carbon nanostructure aerogel in the high heat-resistant carbon nanostructure polymer composite is 30 vol % or greater.

In accordance with some embodiments of the first aspect, the carbon nanostructure includes at least one selected from a group of carbon materials consisting of carbon nanotube (CNT), graphene, graphene oxide, carbon black, carbon nanofiber, and graphite.

In accordance with some embodiments of the first aspect, the thermosetting crosslinked polymer includes at least one selected from a group consisting of epoxy resin, polyimide resin, cyanate resin, phenol resin, melamine resin, silicone resin, urea resin, and unsaturated polyester resin.

A second aspect of the present disclosure provides a method for preparing a hybrid composite, the method comprising: preparing a nanocage structure composed of carbon nanostructure aerogels; mixing a polymer with the nanocage structure to prepare a carbon nanostructure polymer composite layer; stacking the carbon nanostructure polymer composite layer and a polymer layer to prepare an intermediate material layer; providing a carbon fiber layer and stacking the intermediate material layer and the carbon fiber layer on top of each other to form a stack of the intermediate material layer and the carbon fiber layer; and pressing the stack in a mold at a high temperature.

In accordance with some embodiments of the second aspect, the preparing of the nanocage structure composed of the carbon nanostructure aerogels includes preparing a solution in which carbon nanostructures are dissolved in a dispersing liquid, and changing a phase of the prepared solution into a gel state, thereby preparing the nanocage structure composed of the carbon nanostructure aerogels.

In accordance with some embodiments of the second aspect, in the mixing of the polymer with the nanocage structure to prepare the carbon nanostructure polymer composite layer, the polymer exists in a solid powder state at room temperature, wherein the mixing of the polymer with the nanocage structure to prepare the carbon nanostructure polymer composite layer includes: mixing a carbon nanostructure dispersion and the polymer powders with each other to produce an aerogel in which the polymer powders are evenly distributed isotropically within a carbon nanostructure network; and heating the aerogel so that the polymer particles melt and are evenly distributed within the carbon nanostructure network.

In accordance with some embodiments of the second aspect, in the mixing of the polymer with the nanocage structure to prepare the carbon nanostructure polymer composite layer, the polymer exists in a liquid state at room temperature, wherein the mixing of the polymer with the nanocage structure to prepare the carbon nanostructure polymer composite layer includes impregnating the carbon nanostructure aerogel with the polymer.

In accordance with some embodiments of the second aspect, the stack is pressed in the mold at the high temperature such that the carbon nanostructure is impregnated into between carbon fibers of the carbon fiber layer.

In accordance with some embodiments of the second aspect, the method further comprises curing the stack after the pressing of the stack in the mold at a high temperature, wherein the curing includes first curing at 380° C. for 2 hours, and second-curing at 450° C. for 48 hours.

A third aspect of the present disclosure provides a method for preparing a hybrid composite, the method comprising: preparing a nanocage structure composed of carbon nanostructure aerogels; mixing a polymer with the nanocage structure to prepare a carbon nanostructure polymer composite; converting the carbon nanostructure polymer composite into powders; preparing a carbon fiber layer; placing the carbon nanostructure polymer composite powders on at least one of upper and lower surfaces of the carbon fiber layer; and curing the carbon nanostructure polymer composite powders at a high temperature while pressing the carbon nanostructure polymer composite powders against the carbon fiber layer.

In accordance with some embodiments of the third aspect, the preparing of the nanocage structure composed of the carbon nanostructure aerogels includes preparing a solution in which carbon nanostructures are dissolved in a dispersing liquid, and changing a phase of the prepared solution into a gel state, thereby preparing the nanocage structure composed of the carbon nanostructure aerogels.

In accordance with some embodiments of the third aspect, in the mixing of the polymer with the nanocage structure to prepare the carbon nanostructure polymer composite layer, the polymer exists in a solid powder state at room temperature, wherein the mixing of the polymer with the nanocage structure to prepare the carbon nanostructure polymer composite layer includes: mixing a carbon nanostructure dispersion and the polymer powders with each other to produce an aerogel in which the polymer powders are evenly distributed isotropically within a carbon nanostructure network; and heating the aerogel so that the polymer particles melt and are evenly distributed within the carbon nanostructure network.

In accordance with some embodiments of the third aspect, in the mixing of the polymer with the nanocage structure to prepare the carbon nanostructure polymer composite layer, the polymer exists in a liquid state at room temperature, wherein the mixing of the polymer with the nanocage structure to prepare the carbon nanostructure polymer composite layer includes impregnating the carbon nanostructure aerogel with the polymer.

In accordance with some embodiments of the third aspect, the carbon nanostructure polymer composite powders are pressed against the carbon fiber layer such that the carbon nanostructure is impregnated into between carbon fibers of the carbon fiber layer.

A fourth aspect of the present disclosure provides a hybrid composite comprising: a carbon nanostructure polymer composite including: a nanocage structure composed of carbon nanostructure aerogels; and thermosetting crosslinked polymer located in inner pores of the nanocage structure; and carbon fiber tows or carbon fiber layers, wherein the carbon nanostructure polymer composite is disposed in a space between the carbon fiber tows or in a space between the carbon fibers layers.

In accordance with some embodiments of the fourth aspect, the carbon fiber includes a carbon fiber composite.

According to one embodiment of the present disclosure, the high heat-resistant carbon nanostructure polymer composite with an improved glass transition temperature may exhibit a nano-confinement effect in which the crosslinked polymer is confined in the pores of the carbon nanotube aerogel such that the movement of the polymer due to heat is suppressed, thereby ensuring thermal stability.

Furthermore, according to an additional embodiment of the present disclosure, there is provided the hybrid composite with secured thermal stability having the stack structure in which the carbon fiber layer and the intermediate material layer are stacked on top of each other, wherein the intermediate material layer has a stack structure of the high heat-resistant carbon nanostructure polymer composite with an improved glass transition temperature and the polymer. Thus, the hybrid composite with secured thermal stability may be applied to, for example, aerospace materials, automobile materials, etc.

In addition to the effects as described above, specific effects in accordance with the present disclosure will be described together with following detailed descriptions for carrying out the disclosure.

### BRIEF DESCRIPTION OF DRAWINGS

FIG. 1 is a schematic diagram showing a concept of a minimum movable distance ζ of a crosslinked polymer network, and decrease in ζ by an aerogel network, and thus suppression of the polymer movement in a high heat-resistant carbon nanostructure polymer composite.

FIG. 2 is a diagram of a process of preparing a high heat-resistant carbon nanostructure-polymer composite film by impregnating a polymer resin into a carbon nanotube aerogel-shaped nanocage according to an embodiment of the present disclosure.

FIG. 3 shows a graph showing a nano-confinement effect in a carbon nanotube aerogel.

FIG. 4 shows a graph showing change in a storage modulus (E′) of the high heat-resistant carbon nanostructure-polymer composite based on a temperature and based on a carbon nanotube (CNT) content as a result of a dynamic mechanical analysis (DMA) experiment of the high heat-resistant carbon nanostructure polymer composite according to an embodiment.

FIG. 5 shows a graph showing change in a coefficient of thermal expansion of the high heat-resistant carbon nanostructure polymer composite based on a temperature and based on a carbon nanotube content.

FIG. 6 shows a result of measuring a deformation occurring at a given temperature while applying a large load that causes plastic deformation rather than a small load to a film-shaped sample prepared in Example.

FIG. 7 shows improvement of creep resistance characteristics of the composite as measured while hanging a weight on a sample prepared in Example.

FIG. 8 shows a DMA measurement result indicating improvement of heat resistance characteristics of a composite of CNT nanocage and polyimide resin.

FIG. 9 shows a graph showing change in mass based on temperature and based on a carbon nanotube (CNT) content in the high heat-resistant carbon nanostructure polymer composite according to an embodiment.

FIG. 10 shows a result of measuring the heat released when burning the high heat-resistant carbon nanostructure polymer composite according to an embodiment.

FIG. 11 shows a flow chart of a method for preparing a hybrid composite according to an embodiment of the present disclosure.

FIG. 12 is a schematic diagram showing a method for preparing a carbon nanostructure polymer composite layer as a method for producing a composite of CNT aerogel and polymer.

FIG. 13 shows a schematic diagram of a stack in which an intermediate material layer; a carbon fiber layer; and an intermediate material layer are sequentially stacked on top of each other in this order.

FIG. 14 shows a result of measuring the heat resistance of a hybrid composite having a stack structure in which the intermediate material layer; the carbon fiber layer; and the intermediate material layer are sequentially stacked on top of each other in this order.

FIG. 15 shows a result of measuring the heat resistance based on a post-curing condition of a hybrid composite having a stack structure in which the intermediate material layer; the carbon fiber layer; and the intermediate material layer are sequentially stacked on top of each other in this order.

FIG. 16 shows a flow chart of a method for preparing a hybrid composite according to an additional embodiment of the present disclosure.

FIG. 17 shows a schematic diagram of a preparing process of a nanocage carbon fiber hybrid composite according to an additional embodiment of the present disclosure.

FIG. 18 shows heat resistance data of the prepared nanocage carbon fiber hybrid composite.

FIG. 19 shows improvement in the mechanical properties of the prepared nanocage carbon fiber hybrid composite.

FIG. 20 shows a dimension change based on a temperature change of the nanocage carbon fiber hybrid composite.

FIG. 21 shows an experimental diagram of the flame retardancy characteristics of the nanocage carbon fiber hybrid composite.

FIG. 22 shows a comparison diagram of the thermal stability data of the nanocage carbon fiber hybrid composite.

### DETAILED DESCRIPTIONS

Hereinafter, embodiments of the present disclosure will be described in detail with reference to the accompanying drawings. The present disclosure may be subjected to various changes and may have various forms. Thus, particular embodiments will be illustrated in the drawings and will be described in detail herein. However, this is not intended to limit the present disclosure to a specific disclosed form. It should be understood that the present disclosure includes all modifications, equivalents, and replacements included in the spirit and technical scope of the present disclosure. While describing the drawings, similar reference numerals are used for similar components.

Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or some thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In descriptions of temporal relationships, for example, temporal precedent relationships between two events such as “after”, “subsequent to”, “before”, etc., another event may occur therebetween unless “directly after”, “directly subsequent” or “directly before” is not indicated.

The features of the various embodiments of the present disclosure may be partially or entirely combined with each other, and may be technically associated with each other or operate with each other. The embodiments may be implemented independently of each other and may be implemented together in an association relationship.

The present disclosure relates to a high heat-resistant carbon nanostructure polymer composite, and also relates to a hybrid composite including carbon fibers using the high heat-resistant carbon nanostructure polymer composite. The hybrid composite of the present disclosure has a stack structure in which a carbon fiber layer and an intermediate material layer are stacked, wherein the intermediate material layer is composed of the high heat-resistant carbon nanostructure polymer composite and a polymer. Hereinafter, the high heat-resistant carbon nanostructure polymer composite will be described first, and then the hybrid composite including carbon fibers using the high heat-resistant carbon nanostructure polymer composite will be described.

### High Heat-Resistant Carbon Nanostructure Polymer Composite

A high heat-resistant carbon nanostructure polymer composite according to one embodiment of the present disclosure comprises a nanocage structure composed of a carbon nanostructure aerogel; and a thermosetting crosslinked polymer positioned in inner pores of the nanocage structure.

The nanocage structure may be composed of the carbon nanostructure aerogel, and the carbon nanostructure may include at least one selected from a group of carbon materials including carbon nanotubes (CNT), graphene, graphene oxide, carbon black, carbon nanofibers, and graphite. For example, the nanocage structure may be composed of a carbon nanotube (CNT) aerogel. In accordance with the present disclosure, the carbon nanotube (CNT) aerogel used as the nanocage structure is obtained by entirely dispersing carbon nanotubes (CNT) in a dispersing liquid to prepare a dispersion, and converting the dispersion into an aerogel.

In accordance with the present disclosure, the dispersing liquid used to entirely disperse the carbon nanotubes (CNT) therein may be an anionic dispersant which may be selected from the group consisting of SDS (Sodium dodecyl sulfate), LDS (Lithium dodecyl sulfate), NaDDS (Sodium dodecylbenzene sulfonate), SDSA (Sodium dodecyl sulfonate), or SDBS (Sodium dodecylbenzenesulfonate) as alkyl sulfate-based anionic dispersant. Alternatively, the dispersing liquid used to entirely disperse the carbon nanotubes (CNT) therein may be a cationic dispersant which may be selected from the group consisting of CTAC (Cetyltrimethyl ammonium chloride), CTAB (Cetyltrimethyl ammonium bromide), or DTAB (Dodecyl-trimethyl ammonium bromide). Alternatively, the dispersing liquid used to entirely disperse the carbon nanotubes (CNT) therein may be a nonionic dispersant which may be selected from the group consisting of glycerol monostearate, sorbitan monooleate, Tween 80, PVA (Polyvinyl alcohol), PMA (Polymethyl acrylate), MC (Methyl cellulose), and CMC. (Carboxyl methyl cellulose), GA (Gum Arabic), Polysaccharide (Dextrin), PEI (Polyethylenimine), PVP (Polyvinylpyrrolidone) or PEO (Polyethylene oxide), and Poly(ethylene oxide)-Poly(butylene oxide) terpolymer.

When preparing a carbon aerogel precursor, a concentration of the carbon material dispersing liquid may be adjusted. In one example, the concentration of the carbon material dispersing liquid may be adjusted to a value in a range from 0.001 wt % to 30 wt %. In the method for preparing the carbon aerogel precursor according to the present disclosure, the concentration of the carbon material dispersing liquid may be adjusted such that a phase of the carbon material may be changed to a gel phase as an intermediate phase between a liquid phase and a solid phase. A continuous network structure between carbon nanomaterials may be formed, thereby securing mechanical and electrical properties of the finally prepared carbon aerogel precursor.

In one example, in the method for preparing the carbon aerogel precursor according to the present disclosure, a binder may be added. The binder may be used without limitation thereto as long as it is a substance that undergoes a phase transition from a solid phase to a liquid phase depending on the temperature. The binder may be gelatin, cellulose, or chitosan. In the method for preparing the carbon aerogel precursor according to the present disclosure, the binder may be preferably gelatin, chitosan, or cellulose selected from the group consisting of methylcellulose, ethylcellulose, ethylmethylcellulose, hydroxyethyl cellulose, hydroxypropylcellulose, methylhydroxyethylcellulose, ethylhydroxyethylcellulose, hydroxypropylmethylcellulose, carboxymethylcellulose, and mixtures thereof. As long as a polymer exhibits UCST (upper critical solution temperature) behavior, it may be used as the binder without limitation thereto.

According to the present disclosure, a diameter of each of the inner pores of the carbon nanostructure aerogel may be in a range of 0.5 nm to 50 nm, preferably 0.5 nm to 20 nm. In accordance with the present disclosure, the nanocage structure may be composed of the carbon nanotube (CNT) aerogel instead of general carbon nanotube (CNT). The carbon nanotube (CNT) in a form of an aerogel has a pore size in a range of 0.5 nm to 50 nm, preferably 0.5 nm to 20 nm, thereby achieving a nanoconfinement effect in which movement of the polymer due to heat is suppressed while the polymer is trapped in the pores of the aerogel.

In one example, a content of the carbon nanotube (CNT) in the carbon nanotube (CNT) aerogel may be in a range of 0.01 wt % to 10 wt %, preferably 0.05 wt % to 10 wt %, relative to a total weight of the carbon nanotube (CNT) aerogel. When the content of the carbon nanotube (CNT) in the carbon nanotube (CNT) aerogel of the present disclosure is smaller than 0.01 wt % based on the total weight of the carbon nanotube (CNT) aerogel, the mobility of the polymer chain is not suppressed. When the content exceeds 10 wt % based on the total weight of the carbon nanotube (CNT) aerogel, the polymer resin is not impregnated into the aerogel during composite production.

The crosslinked polymer includes a thermosetting crosslinked polymer located in the inner pores of the nanocage structure, and includes at least one selected from the group consisting of epoxy resin, polyimide resin, cyanate resin, phenol resin, melamine resin, silicone resin, urea resin, and unsaturated polyester resin. The thermosetting resin exhibits stable mechanical properties at a temperature below a glass transition temperature after the crosslinking reaction. On the other hand, at a temperature higher than the glass transition temperature, polymer chain flow is activated, such that mechanical strength and stiffness decrease.

The thermosetting resin used in the present disclosure may include a material that has a viscosity and molecular weight controlled such that the material may be injected into the carbon nanotube aerogel before curing thereof, and may be crosslinked under heat or UV. The material may include epoxy resin, polyimide resin, epoxy resin, polyimide resin, epoxy resin, polyimide resin, cyanester resin, phenol resin, melamine resin, silicone resin, urea resin, and unsaturated polyester resin. For example, the thermosetting resin of the present disclosure may include a thermosetting polyimide (Oligo-P) modified with a reactive group at an end of an imide oligomer having a small molecular weight. The thermosetting polyimide (Oligo-P) modified with the reactive group at the end of the imide oligomer of the small molecular weight is characterized by having a size such that that the thermosetting polyimide modified with the reactive group at the end of the imide oligomer of the small molecular weight may be trapped in the pores of the carbon nanotube aerogel, and is characterized in that molecules chemically crosslink with each other through a subsequent thermosetting process, thereby having mechanical and thermal stability even at high temperatures.

A content of the crosslinked polymer may be in a range of 10 wt % to 90 wt %, preferably 20 wt % to 90 wt %, based on a total weight of the high heat-resistant carbon nanostructure polymer composite. When the content of the crosslinked polymer is smaller than 10 wt % based on a total weight of the high heat-resistant carbon nanostructure-polymer composite, there may be a problem that the mechanical properties of the composite are not sufficient. When the content exceeds 90 wt %, there may be a problem that the improvement in the glass transition temperature due to the nano-confinement effect cannot be expected.

The high heat-resistant carbon nanostructure polymer composite of the present disclosure has thermal stability due to the nano-confinement effect in which the cross-linked polymer is confined in the pores of the carbon nanotube aerogel such that movement thereof due to heat is suppressed. In this case, in the high heat-resistant carbon nanostructure polymer composite according to the present disclosure, a minimum length by which the polymer located in the inner pores of the nanocage structure can move under the glass transition temperature is smaller than a minimum length by which the polymer itself can move under the glass transition temperature. This may be expressed based on a following Equation 1.

$$ζ < {ζ}_{Bulk polymer} ( 2 Δ = {ζ}_{composite} ) < {ζ}_{Tg , neat polymer} \qquad [ Equation l ]$$

In this regard, ζ is the minimum length by which the thermosetting resin can move in the composite under the glass transition temperature or a size of a space in the nanocage structure where the crosslinked polymer may exist. ζ_{Bulk polymer} means the minimum length by which the crosslinked polymer itself can move under the glass transition temperature.

According to the present disclosure, the molecular weight Mw of the thermosetting polymer increases almost infinitely as is cured. Thus, it is difficult to define the radius of rotation Rg of the molecule. Therefore, the concept of CRR (Cooperative Rearrangement Range) that expresses the change in polymer movement due to heat is introduced. A minimum space CRR for the mobility of the crosslinked polymer to be activated at the glass transition temperature may be expressed as ζ³. This is a volume scale. This may be converted to a length scale which may be expressed as ζ. In order to suppress the mobility of the polymer, the above Equation 1 should be satisfied.

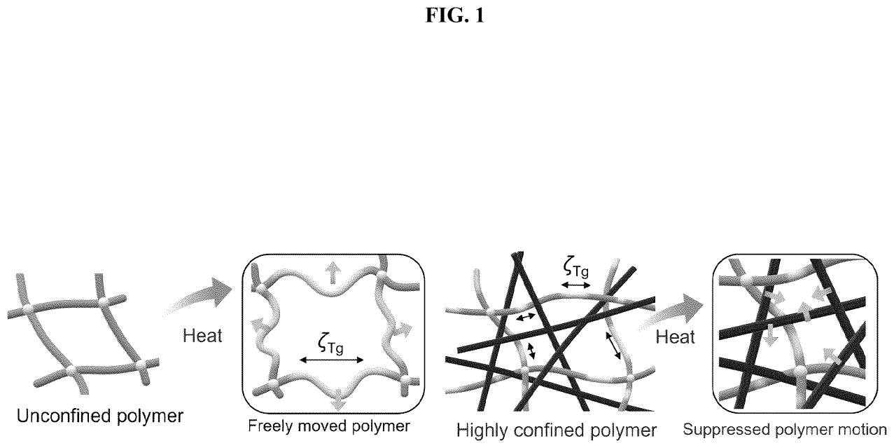

In accordance with the present disclosure, using the carbon nanotube aerogel, an area CRR where the polymer chain can move is reduced (more localized motion of polymer) due to the complex carbon nanotube network. Accordingly, the effect of increasing Tg resulting from the increase in the crosslink density of the polymer via the introduction of the carbon nanotube nanocages may be obtained. This may be identified in the schematic diagram showing the concept of the minimum movable distance ζ of the cross-linked polymer network, and the decrease in ζ by the aerogel network and, thus, the suppression of the polymer movement in the high heat-resistant carbon nanostructure polymer composite, as shown in FIG. 1.

In one example, a correlation between a distance between the carbon nanostructure aerogels in the polymer matrix and a volume fraction of the carbon nanostructure aerogel in the high heat-resistant carbon nanostructure polymer composite may be expressed based on a following Equation 2:

$$\frac{Δ}{R} = \sqrt{\frac{{V}_{f , max}}{{V}_{f}}} - 1 \qquad [ Equation 2 ]$$

In the Equation 2, 2Δ is a distance between nanotubes in the carbon nanostructure aerogel, R is a radius of each of the nanotubes that constitutes the carbon nanostructure aerogel, V_{f,max} is a maximum volume fraction of the carbon nanostructure aerogel, and V_{f} means the volume fraction of the carbon nanostructure aerogel. In order to increase the glass transition temperature of the composite, ζ should be smaller than a minimum movable distance ζ_{neat polymer} of the neat polymer, and ζ may be expressed as the aerogel network size 2Δ in the composite.

In summary, the high heat-resistant carbon nanostructure polymer composite of the present disclosure may have a reduced area (CRR) in which chains can move due to the complex carbon nanostructure network. The introduction of the nanocage structure may increase the crosslinking density of the polymer, resulting in an increase in Tg. In this case, when the carbon nanotube nanocage is used, the distance between CNT and CNT may be reduced to the nanometer level as Vf increases. The distance between CNT and CNT may be smaller than ζ_{Bulk polymer} such that the movement of the polymer may be suppressed. That is, it is easy to implement the spacing 2Δ between nano-sized carbon nanostructures using CNTs. In when the content of the carbon nanostructure aerogel included in the high heat-resistant carbon nanostructure polymer composite of the present disclosure is 10 vol % or greater, the above-mentioned restraining or suppressing effect in which the polymer movement may be suppressed may occur. The content of the carbon nanostructure aerogel in the high heat-resistant carbon nanostructure polymer composite of the present disclosure may be 20 vol % or greater, and preferably 30 vol % or greater. Hereinafter, the contents of the present disclosure will be described in more detail with specific examples.

### EXAMPLE 1

In Example 1, the high heat-resistant carbon nanostructure polymer composite as described above is described in detail.

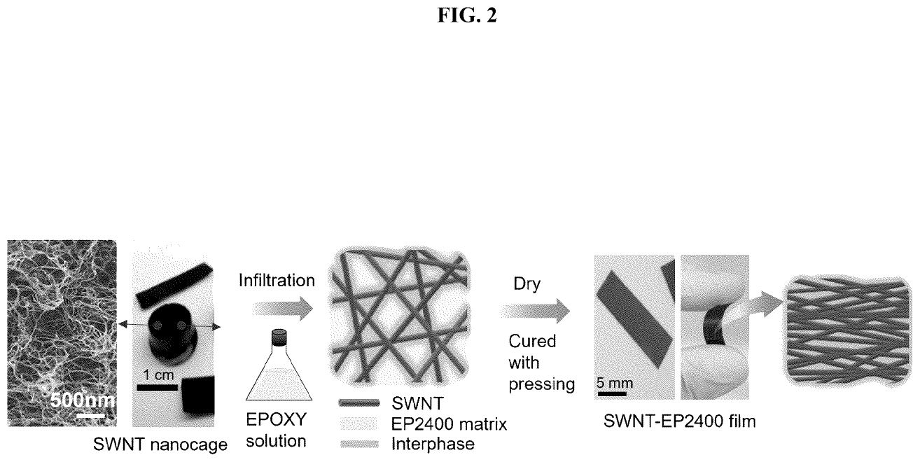

FIG. 2 is a diagram of a process for preparing a high heat-resistant carbon nanostructure-polymer composite film by impregnating a polymer resin into a carbon nanotube aerogel-shaped nanocage according to one embodiment of the present disclosure.

As shown in FIG. 2, carbon nanotube nanocages constituting a network are placed in a polymer solution to impregnate the polymer into the network pores. Afterwards, the water or solvent within the nanocage is dried, and a carbon nanotube-polymer composite film in which polymer coated on the carbon nanotube surface is pressed is cured using hot pressing to form a composite, thereby finally producing a composite film. Specifically, a solution in which 0.1 g carbon nanotube (CNT) is dissolved in 10 ml of SDS (Sodium dodecyl sulfate) as a dispersing liquid containing 1 wt % of surfactant is subjected to an ultrasonic dispersion and concentration process to change the phase of the solution into a gel state, thereby preparing a carbon nanotube (CNT) hydrogel precursor. Afterwards, the carbon nanotube (CNT) hydrogel precursor is subjected to a freeze-drying or critical drying process such that the nanocage structure composed of the aerogels is prepared. Next, the inner pores of the nanocage structure are impregnated with epoxy as the thermosetting resin, followed by heat-curing, thereby preparing the carbon nanotube-polymer composite.

SWNT nanocages constitute a 3D network in which the carbon nanotubes (CNT) are completely individually dispersed. The pore size distribution is smaller than 10 nm and a specific surface area (SSA) is 1,210 m²/g.

In preparing the high heat-resistant carbon nanostructure polymer composite as mentioned above, ζ_{Tg} based on the content of the carbon nanotube aerogel is measured through DSC analysis, and the result is shown in Table 1 as set forth below.

TABLE 1

| CNT | Distance between | CRR (by MDSC) | Length of | Tg |
|---|---|---|---|---|
| vol % | nanotubes (nm) | (nm³) | Tg (nm) | (° C.) |
| 0 | — | 9.1 | 2.1 (=ζ_{Bulk polymer}) | 156 |
| 11 | 1.86 | 4.1 | 1.59 | 152 |
| 31 | 0.58 | 0.11 | 0.48 | 200 |
| 37 | 0.4 | 0.058 | 0.39 | 204 |

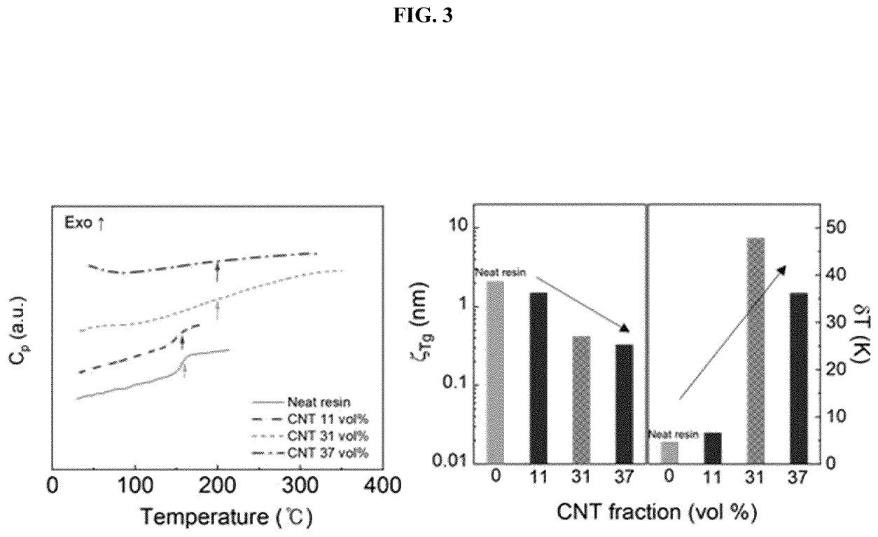

As shown in Table 1, it is identified that the ζ_{Tg} value decreases as the content (vol %) of the carbon nanotube aerogel in the carbon nanostructure polymer composite increases. FIG. 3 shows a graph showing the nano-confinement effect in the carbon nanotube aerogel. As shown in Table 1 and FIG. 3, when the content of the carbon nanostructure aerogel in the high heat-resistant carbon nanostructure polymer composite is 10 vol % or greater, a movement restraining or confinement effect that restricts the movement of the polymer as above may occur. The content of the carbon nanostructure aerogel may be 20 vol % or greater. Preferably, the content of the carbon nanostructure aerogel may be 30 vol % or greater.

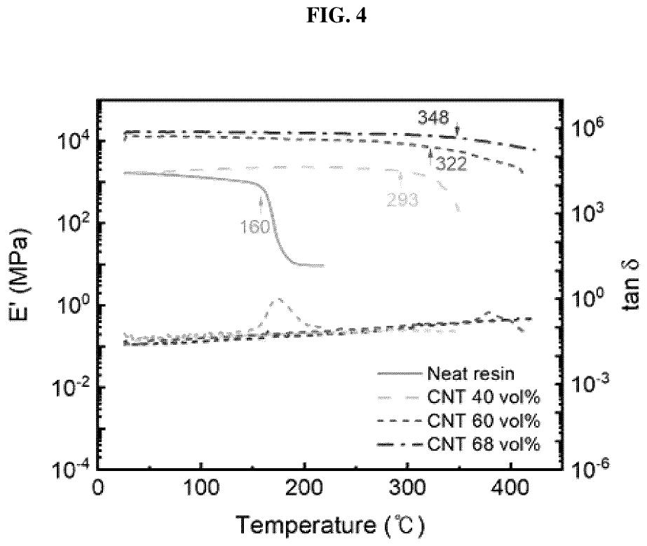

FIG. 4 shows a graph showing change in a storage modulus (E′) of the high heat-resistant carbon nanostructure-polymer composite based on a temperature and based on a carbon nanotube (CNT) content as a result of a dynamic mechanical analysis (DMA) experiment of the high heat-resistant carbon nanostructure polymer composite according to an embodiment. Specifically, FIG. 4 shows the storage modulus (E′) value based on the temperature of each of a neat resin (polymer 100%) and a CNT+polymer composite (with varying CNT content). The specimen is hung on a DMA (Dynamic Mechanical Analyzer), and measurements are made while fixing the strain at 5% and the frequency at 1 Hz and increasing the temperature. The graph shows that in the neat resin, as the temperature increases, the movement of the polymer chain increases around 160° C., causing the resin to be fluid. However, the graph shows that Tg of the composite in which CNT acts as a nanocage is at most two times of Tg of the neat resin. This is because the CNT nanocage confines the polymer chain to prevent the polymer chain from moving until the temperature reaches the temperature Tg.

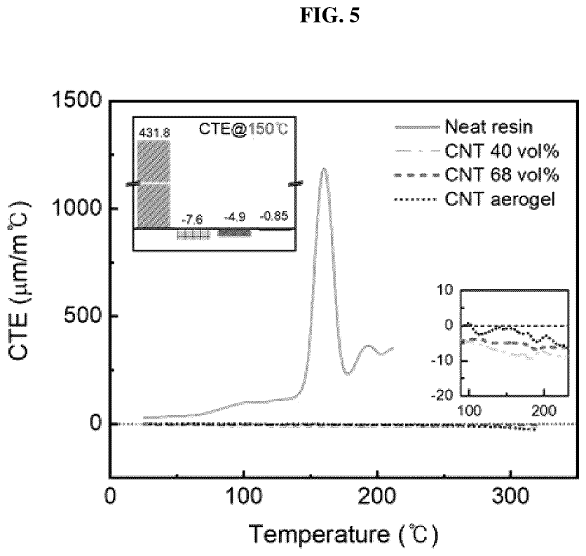

FIG. 5 is a graph showing the change in the coefficient of thermal expansion based on a carbon nanotube content of the high heat-resistant carbon nanostructure polymer composite according to an embodiment. Specifically, FIG. 5 shows the coefficient of thermal expansion based on a temperature of each of the neat resin (100% polymer) and the CNT+polymer composite. Using the TMA (Thermomechanical Analyzer), the length change relative to the initial length according to temperature increase is measured while applying a small load of 0.01N to a film-shaped sample. Referring to FIG. 5, it is identified that as the content of CNT nanocages in the composite increases, the CTE value (coefficient of thermal expansion) of the composite has a lower value of almost 1/500 at the glass transition temperature (150° C.) of the polymer resin. Furthermore, it is identified that since the movement of the polymer in the nanocage is suppressed, the dimensional stability of the composite is very high even at a temperature above the glass transition temperature of the polymer.

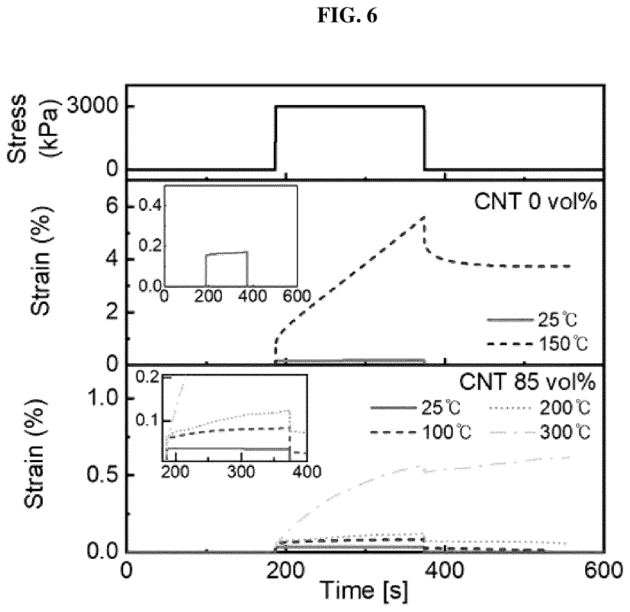

FIG. 6 shows a result of measuring a deformation occurring at a given temperature while applying a large load that causes plastic deformation rather than a small load to a film-shaped sample prepared in Example. The CNT+resin composite film exhibits excellent creep characteristics at a stress of 3000 kPa due to the influence of the CNT nanocage. In the neat resin, 6% deformation occurs at 150° C., whereas in the CNT+resin composite, only 0.6% deformation occurs even at a higher temperature of 300° C.

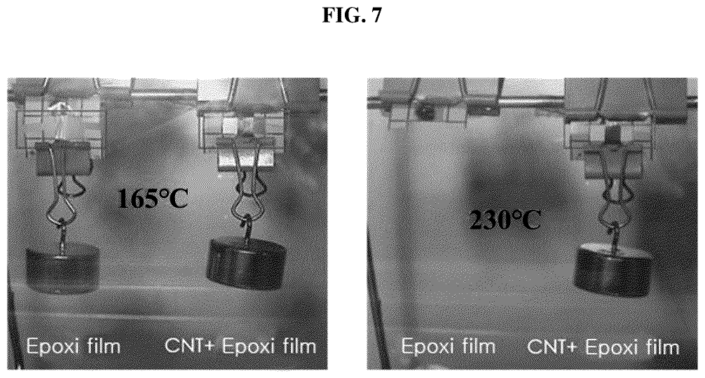

FIG. 7 shows improvement of creep resistance characteristics of the composite as measured while hanging a weight on a sample prepared in Example. It is identified that the neat resin and the CNT+resin samples with the same weight (50 g) exhibit different characteristics. The neat resin broke after 165° C., while the CNT+resin composite does not break until 230° C.

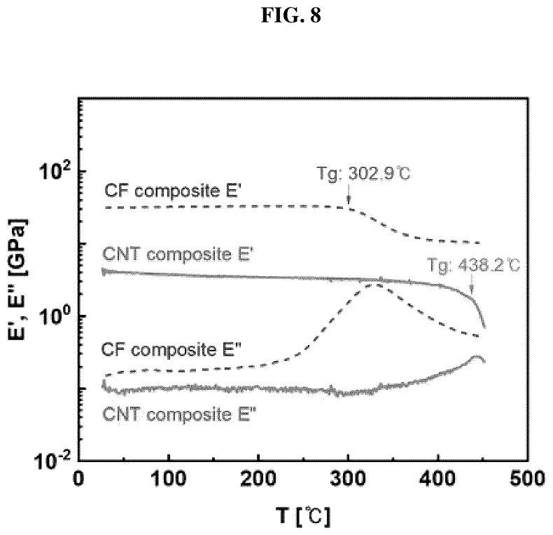

FIG. 8 shows the result of DMA measurement indicating the improvement of heat resistance characteristics of the composite of CNT nanocages and polyimide resin. As shown in FIG. 8, it is identified when carbon fiber (CF) is used, the improvement of heat resistance characteristics is not good, whereas when carbon nanotubes (CNT) are used, the improvement of heat resistance characteristics is achieved. It is identified that Tg of the composite increases by more than 45% to approximately 438° C. Thus, it is identified that the composite may be applied to high-temperature resins.

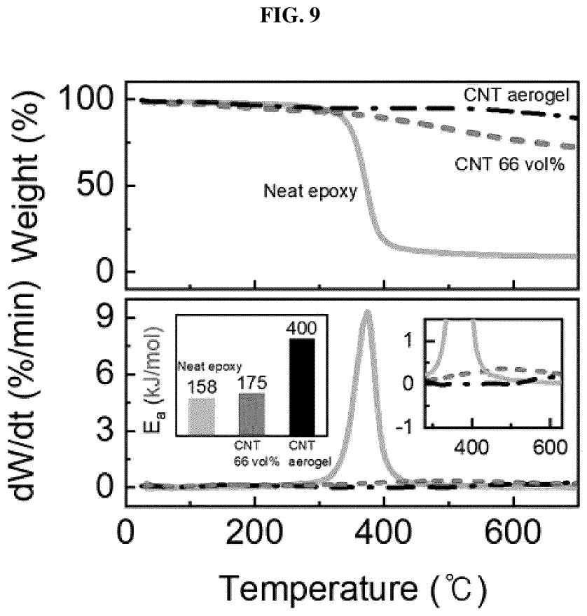

FIG. 9 shows a graph showing change in mass based on a temperature and based on a carbon nanotube (CNT) content in the high heat-resistant carbon nanostructure polymer composite according to an embodiment. Specifically, FIG. 9 shows the TGA result measuring the weight loss based on the temperature as measured at a heating rate of 10° C./min in an N₂ atmosphere. It may be identified that the neat polymer free of the carbon nanotubes is entirely thermally decomposed around 380° C., whereas the nanocage composite exhibits the maximum mass change after 500° C., so that the activation energy and temperature for the thermal decomposition of the composite increases. When the CNT/resin composite is burned in an inert gas, a larger amount remains than an amount remaining after individually burning each of the resin and the CNT. Further, when the CNT/resin composite is burned in an inert gas, not only the resin but also the CNT is less damaged by heat. It is identified that the peak value of the mass change rate (dW/dt) over time of the CNT/resin composite shifts to a higher temperature, indicating the improvement in the thermal stability.

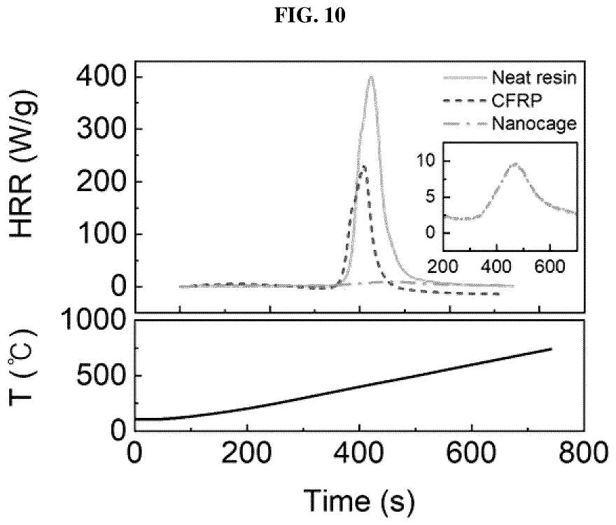

FIG. 10 shows the result of measuring the heat released during combustion of a high heat-resistant carbon nanostructure polymer composite according to an embodiment. The value of the heat released during the combustion is HRR (Heat Release Rate), and the combustion is simulated by instantaneously increasing the temperature up to 900° C. at a heating rate of 1° C./s. As a result, the heat released (HRR) generated during combustion (including oxygen) of the CNT/epoxy resin (ex. EP2400) composite is also very low (flame retardant characteristics). Each of a time duration for which and a temperature at which the heat release has reached a maximum value in the combustion of the composite using the nanocage is also shifted to a greater value or higher value, indicating that the composite using the nanocage has excellent flame retardant characteristics.

In one embodiment, a method for preparing a high heat-resistant carbon nanostructure polymer composite according to an embodiment of the present disclosure includes a step of preparing a nanocage structure composed of carbon nanostructure aerogel s; and a step of mixing a polymer with the nanocage structure to prepare the carbon nanostructure polymer composite layer.

The step of preparing of the nanocage structure composed of the carbon nanostructure aerogels includes preparing a solution in which carbon nanostructures are dissolved in a dispersing liquid, and changing a phase of the prepared solution into a gel state, thereby preparing the nanocage structure composed of the carbon nanostructure aerogels.

In the step of mixing the polymer with the nanocage structure to prepare the carbon nanostructure polymer composite layer, the polymer may exist in a solid powder state at room temperature or may exist in a liquid state.

When the polymer exists in a solid powder state at room temperature, the carbon nanostructure dispersion and the polymer powders are mixed with each other to produce an aerogel in which the polymer powders are evenly distributed isotropically within the carbon nanostructure network. The aerogel is heated so that the polymer particles melt and are evenly distributed within the carbon nanostructure network.

When the polymer exists in a liquid state at room temperature, the polymer is melted and impregnated into the carbon nanostructure aerogel.

In a specific preparation example, first, a solution in which 0.1 g carbon nanotube (CNT) is dissolved in 10 ml of a dispersing liquid containing 1 wt % surfactant is subjected to an ultrasonic dispersion and concentration process to change the phase of the solution into a gel state, thereby preparing the carbon nanotube (CNT) hydrogel precursor. Then, the carbon nanotube (CNT) hydrogel precursor is subjected to a freeze-drying or critical drying process, such that the nanocage structure composed of the aerogels is prepared. Next, the inner pores of the nanocage structure are impregnated with the epoxy as the thermosetting resin mainly composed of a resin and a hardener, and then thermal curing is performed thereon to prepare the carbon nanotube-polymer composite. In this case, as shown in FIG. 4, as the content of CNT nanocages in the composite increases, the stiffness (E′) of the composite increases and the glass transition temperature Tg of the composite increases from 160° C. before applying the carbon nanotubes to a maximum of 348° C. As shown in FIG. 5, as the content of CNT nanocages in the composite increases, the CTE (coefficient of thermal expansion) of the composite has a low value of almost 1/500 of the glass transition temperature of the polymer resin. Furthermore, referring to FIG. 9, it may be identified that the neat polymer free of the carbon nanotubes is entirely oxidized around 380° C., while the nanocage composite has a maximum mass change after 500° C., such that the activation energy and temperature for thermal decomposition of the composite increase.

The present disclosure has described the high heat-resistant carbon nanostructure polymer composite above. Hereinafter, the present disclosure will describe the hybrid composite including the carbon fibers using the high heat-resistant carbon nanostructure polymer composite. The descriptions of contents duplicate with the contents described above will be omitted.

### Hybrid Composite Including Carbon Fibers Using High Heat-Resistant Carbon Nanostructure Polymer Composite

The present disclosure provides a hybrid composite including carbon fibers using the high heat-resistant carbon nanostructure polymer composite as described above. When using the high heat-resistant carbon nanostructure polymer composite in practice, carbon fibers are often required. Depending on the intended use, carbon fibers are converted into a composite for use. In this case, the high heat-resistant carbon nanostructure polymer composite may be used as an intermediate material.

The carbon nanostructure aerogels are generally carbon nanotube aerogels which have high specific surface area, smaller pore size of smaller than 20 nm, are individually dispersed, and constitute a network structure. The carbon nanotube aerogel not only contributes to improving the heat resistance of the polymer, but also improves the compression strength when being hybridized with the carbon fibers.

A type of the carbon fibers may vary depending on the application. For example, when the carbon fibers are used for a lightweight structural composite, the carbon fibers with a density of 1.3 to 1.7 g/cm³ may be used. When the carbon fiber content is 60%, the composite may exhibit a strength of 900 to 2500 MPa. A variety of carbon fibers may be used.

The polymer may be a thermosetting polymer or a high-temperature polymer as described above. For example, the polymer may include polyimide resins, bismaleimide, cyanate ester, etc., which maintain mechanical properties at a temperature range from 150 to 350° C. and exhibit a density of 1.3 g/cm³.

That is, in the hybrid composite including carbon fibers using the high heat-resistant carbon nanostructure polymer composite of the present disclosure, the thermosetting high-temperature resin and the nanocage may be combined into the composite using the nano-confinement effect of the nanocage restricting the movement of the polymer, thereby increasing the heat resistance (Tg) of the hybrid composite at high temperatures, and satisfying structural stability of the hybrid via hybridization with carbon fibers (CF) having light weight and high strength.

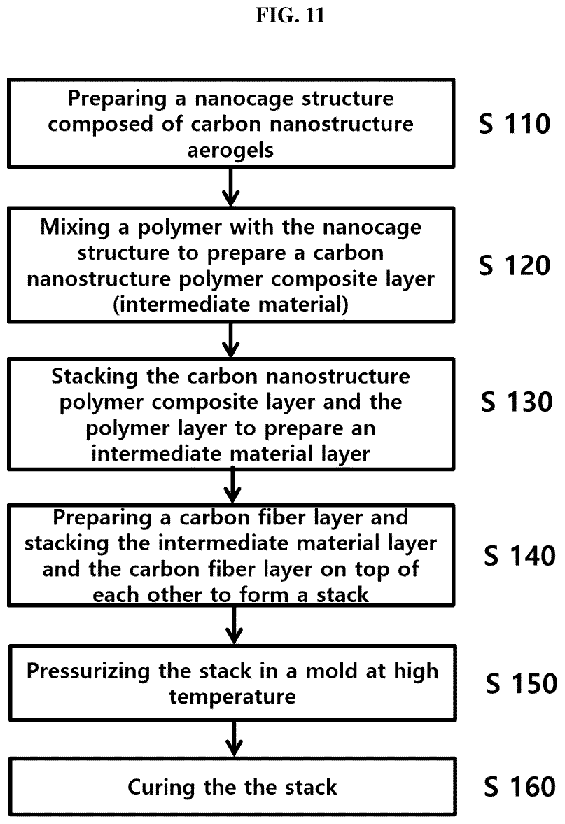

FIG. 11 illustrates a flow chart of a method for preparing a hybrid composite according to an embodiment of the present disclosure. As illustrated in FIG. 11, the method for preparing the hybrid composite according to an embodiment of the present disclosure includes a step S110 of preparing a nanocage structure composed of carbon nanostructure aerogels; a step S120 of mixing a polymer with the nanocage structure to prepare a carbon nanostructure polymer composite layer (intermediate material); a step S130 of stacking the carbon nanostructure polymer composite layer and the polymer layer to prepare an intermediate material layer; a step S140 of preparing a carbon fiber layer and stacking the intermediate material layer and the carbon fiber layer on top of each other to form a stack; and a step S150 of pressurizing the stack in a mold at high temperature. In accordance with the present disclosure, the intermediate material is a concept including the CNT aerogel; and polymer powders. The intermediate material layer is a concept the intermediate material and an additional resin film or additional resin powders. Specifically, the intermediate material layer is a concept including a stack of CNT aerogel; polymer powders; and an additional resin film or resin powders.

In step S110, the nanocage structure composed of carbon nanostructure aerogels is prepared. In this regard, a solution in which carbon nanostructure is dissolved in a dispersing liquid is phase-changed into a gel state to prepare a nanocage structure composed of carbon nanostructure aerogels.

In accordance with the present disclosure, the dispersing liquid used to entirely disperse the carbon nanotubes (CNT) therein may be an anionic dispersant which may be selected from the group consisting of SDS (Sodium dodecyl sulfate), LDS (Lithium dodecyl sulfate), NaDDS (Sodium dodecylbenzene sulfonate), SDSA (Sodium dodecyl sulfonate), or SDBS (Sodium dodecylbenzenesulfonate) as alkyl sulfate-based anionic dispersant. Alternatively, the dispersing liquid used to entirely disperse the carbon nanotubes (CNT) therein may be a cationic dispersant which may be selected from the group consisting of CTAC (Cetyltrimethyl ammonium chloride), CTAB (Cetyltrimethyl ammonium bromide), or DTAB (Dodecyl-trimethyl ammonium bromide). Alternatively, the dispersing liquid used to entirely disperse the carbon nanotubes (CNT) therein may be a nonionic dispersant which may be selected from the group consisting of glycerol monostearate, sorbitan monooleate, Tween 80, PVA (Polyvinyl alcohol), PMA (Polymethyl acrylate), MC (Methyl cellulose), and CMC. (Carboxyl methyl cellulose), GA (Gum Arabic), Polysaccharide (Dextrin), PEI (Polyethylenimine), PVP (Polyvinylpyrrolidone) or PEO (Polyethylene oxide), and Poly(ethylene oxide)-Poly(butylene oxide) terpolymer.

When preparing a carbon aerogel precursor, a concentration of the carbon material dispersing liquid may be adjusted. In one example, the concentration of the carbon material dispersing liquid may be adjusted to a value in a range from 0.001 wt % to 30 wt %.

In preparing the carbon aerogel precursor according to the present disclosure, the concentration of the carbon material dispersing liquid may be adjusted such that a phase of the carbon material may be changed to a gel phase as an intermediate phase between a liquid phase and a solid phase. A continuous network structure between carbon nanomaterials may be formed, thereby securing mechanical and electrical properties of the finally prepared carbon aerogel precursor.

Furthermore, in preparing the carbon aerogel precursor according to the present disclosure, a binder may be added, and the binder may be freely used without limitation as long as it is a material that undergoes a phase transition from a solid phase to a liquid phase depending on the temperature.

The binder may be gelatin, cellulose, or chitosan. In the step for preparing the carbon aerogel precursor according to the present disclosure, the binder may be preferably gelatin, chitosan, or cellulose selected from the group consisting of methylcellulose, ethylcellulose, ethylmethylcellulose, hydroxyethyl cellulose, hydroxypropylcellulose, methylhydroxyethylcellulose, ethylhydroxyethylcellulose, hydroxypropylmethylcellulose, carboxymethylcellulose, and mixtures thereof. As long as a polymer exhibits UCST (upper critical solution temperature) behavior, it may be used as the binder without limitation thereto.

According to the present disclosure, a diameter of each of the inner pores of the carbon nanostructure aerogel may be in a range of 0.5 nm to 50 nm, preferably 0.5 nm to 20 nm. In accordance with the present disclosure, the nanocage structure may be composed of the carbon nanotube (CNT) aerogel instead of general carbon nanotube (CNT). The carbon nanotube (CNT) in a form of an aerogel has a pore size in a range of 0.5 nm to 50 nm, preferably 0.5 nm to 20 nm, thereby achieving a nanoconfinement effect in which movement of the polymer due to heat is suppressed while the polymer is trapped in the pores of the aerogel.

In one example, a content of the carbon nanotube (CNT) in the carbon nanotube (CNT) aerogel may be in a range of 0.01 wt % to 10 wt %, preferably 0.05 wt % to 10 wt %, relative to a total weight of the carbon nanotube (CNT) aerogel. When the content of the carbon nanotube (CNT) in the carbon nanotube (CNT) aerogel of the present disclosure is smaller than 0.01 wt % based on the total weight of the carbon nanotube (CNT) aerogel, the mobility of the polymer chain is not suppressed. When the content exceeds 10 wt % based on the total weight of the carbon nanotube (CNT) aerogel, the polymer resin is not impregnated into the aerogel during composite production.

The crosslinked polymer includes a thermosetting crosslinked polymer located in the inner pores of the nanocage structure, and includes at least one selected from the group consisting of epoxy resin, polyimide resin, cyanate resin, phenol resin, melamine resin, silicone resin, urea resin, and unsaturated polyester resin. The thermosetting resin exhibits stable mechanical properties at a temperature below a glass transition temperature after the crosslinking reaction. On the other hand, at a temperature higher than the glass transition temperature, polymer chain flow is activated, such that mechanical strength and stiffness decrease.

The thermosetting resin used in the present disclosure may include a material that has a viscosity and molecular weight controlled such that the material may be injected into the carbon nanotube aerogel before curing thereof, and may be crosslinked under heat or UV. The material may include epoxy resin, polyimide resin, epoxy resin, polyimide resin, epoxy resin, polyimide resin, cyanester resin, phenol resin, melamine resin, silicone resin, urea resin, and unsaturated polyester resin. For example, the thermosetting resin of the present disclosure may include a thermosetting polyimide (Oligo-P) modified with a reactive group at an end of an imide oligomer having a small molecular weight. The thermosetting polyimide (Oligo-P) modified with the reactive group at the end of the imide oligomer of the small molecular weight is characterized by having a size such that that the thermosetting polyimide modified with the reactive group at the end of the imide oligomer of the small molecular weight may be trapped in the pores of the carbon nanotube aerogel, and is characterized in that molecules chemically crosslink with each other through a subsequent thermosetting process, thereby having mechanical and thermal stability even at high temperatures.

A content of the crosslinked polymer may be in a range of 10 wt % to 90 wt %, preferably 20 wt % to 90 wt %, based on a total weight of the high heat-resistant carbon nanostructure polymer composite. When the content of the crosslinked polymer is smaller than 10 wt % based on a total weight of the high heat-resistant carbon nanostructure-polymer composite, there may be a problem that the mechanical properties of the composite are not sufficient. When the content exceeds 90 wt %, there may be a problem that the improvement in the glass transition temperature due to the nano-confinement effect cannot be expected.

In step S120, the polymer is mixed with the nanocage structure to prepare a carbon nanostructure polymer composite layer. In the step of mixing the polymer with the nanocage structure to prepare the carbon nanostructure polymer composite layer, the polymer may exist in a solid powder state at room temperature or may exist in a liquid state.

When the polymer exists in a solid powder state at room temperature, the carbon nanostructure dispersion and the polymer powders are mixed with each other to produce an aerogel in which the polymer powders are evenly distributed isotropically within the carbon nanostructure network. The aerogel is heated so that the polymer particles melt and are evenly distributed within the carbon nanostructure network.

It is important to create a state in which the CNTs (carbon nanotubes) are well dispersed in a state in which strands thereof are spaced from each other. For this purpose, a well-dispersed CNT dispersion is used, and the resin powders are mixed into the well-dispersed CNT dispersion. As a result, the resin particles are evenly distributed within the CNT network (nano-cage). In this state, the polymer is impregnated therein to create a CNT+polymer intermediate (aerogel). The CNT+polymer aerogel is heated to a temperature so that the resin particles (polymer particles) melt and are evenly distributed on the surface of the CNT. When the resin melts, the resin is evenly distributed within the CNT network. The intermediate material as created in this way may be used in a form of a film or may be ground.

When the polymer exists in a liquid state at room temperature, the polymer is melted and impregnated into the carbon nanostructure aerogel to create the carbon nanostructure polymer composite layer.

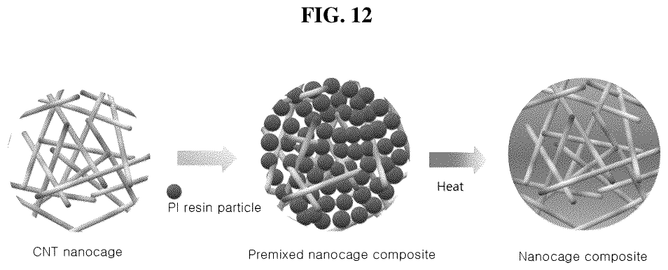

FIG. 12 is a schematic diagram illustrating the method for preparing the carbon nanostructure polymer composite layer as a method for producing the composite of CNT aerogel and polymer.

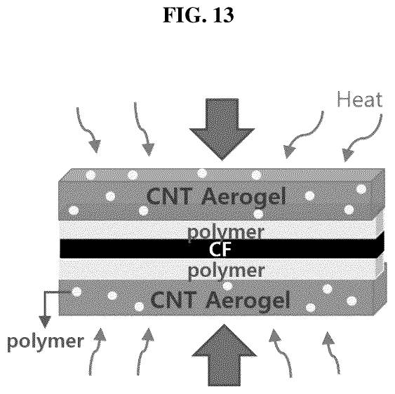

In step S130, the carbon nanostructure polymer composite layer and the polymer layer are stacked on top of each other to prepare the intermediate material layer. As shown in FIG. 13, the carbon nanostructure polymer composite layer (CNT Aerogel) (intermediate material) and the polymer layer (polymer) may be stacked on top of each other form to create the intermediate material layer. In FIG. 13, this intermediate material layer and the carbon fiber are stacked on top of each other to form a stack of intermediate material layer/carbon fiber layer/intermediate material layer. In this case, the polymer of the polymer layer may be the same as the polymer of the carbon nanostructure polymer composite layer.

In step S140, the carbon fiber layer is prepared, and the intermediate material layer and the carbon fiber layer are stacked on top of each other to form a stack. In this case, according to an embodiment, the intermediate material layer; the carbon fiber layer; and the intermediate material layer may be sequentially stacked on top of each other (in this case, respective polymer layers of upper and lower intermediate material layers contact the carbon fiber layer). In another embodiment, the carbon fiber layer; intermediate material layer; carbon fiber layer may be sequentially stacked on top of each other. Depending on the purpose of the CF, various types of carbon fibers (CF) may be used. Examples thereof may include PAN (polyacrylonitrile)-based carbon fibers, pitch-based carbon fibers, rayon-based carbon fibers, and various woven fibers (Unidirectional fibers or woven fibers).

In step S150, the stack is pressed at the high temperature pressure while being received in a mold. The stack is pressed at the high temperature pressure while being received in the mold, such that the carbon nanostructure may be vertically impregnated into between the carbon fibers.

After step S150, a curing step S160 may be additionally included in the method. In this case, after the curing has been performed, additional post-curing may be performed to exhibit high heat resistance.

The hybrid composite according to an additional embodiment of the present disclosure includes a stack structure in which the intermediate material layer and the carbon fiber layer are stacked on top of each other.

In this case, the intermediate material layer includes the carbon nanostructure polymer composite layer and the polymer layer, wherein the carbon nanostructure polymer composite layer includes the nanocage structure composed of carbon nanostructure aerogels; and the thermosetting crosslinked polymer located in the inner pores of the nanocage structure. The intermediate material layer has the stack structure in which the carbon nanostructure polymer composite layer; and the polymer layer are stacked on top of each other.

In one embodiment, the hybrid composite may have the stack structure in which the intermediate material layer; the carbon fiber layer; and the intermediate material layer are stacked on top of each other in this order (CNT/CF/CNT). In another embodiment, the hybrid composite may have the stack structure in which the carbon fiber layer; the intermediate material layer; and the carbon fiber layer are stacked on top of each other in this order (CF/CNT/CF). Hereinafter, further description will be additionally made based on specific examples.

### EXAMPLE 2

In Example 2, a CNT and CF hybrid composite is prepared. FIG. 13 shows a schematic diagram of a stack structure in which the intermediate material layer; the carbon fiber layer; and the intermediate material layer are stacked on top of each other in this order.

First, the CNT+polymer intermediate material is prepared. The CNT aerogel and the polymer are combined with each other, as shown in FIG. 12. In this case, the polymer may exist in a solid powder state at room temperature or a liquid state. This has already been described in detail above.

Next, the intermediate material including CNT and the CF (carbon fiber) are combined each other into the composite. The carbon fiber may be a plane woven carbon fiber, and this plane woven carbon fiber may be used in various high-performance applications such as aerospace, automobiles, and sports equipment. As shown in FIG. 13, the CNT+Polymer intermediate layer and the CF layer are stacked on top of each other to form a stack. The stack may be pressed at the high-temperature (10 tons at a temperature of about 380° C.) while being received in the mold so that the CNT may be vertically impregnated into between the CFs, and then cured at a temperature of about 380° C. for 2 hours. A plurality of intermediate layers and a plurality of CF layers may be stacked on top of each other in an alternate manner with each other. In the example of FIG. 13, the intermediate material layer; the carbon fiber layer; and the intermediate material layer are stacked on top of each other in this order.

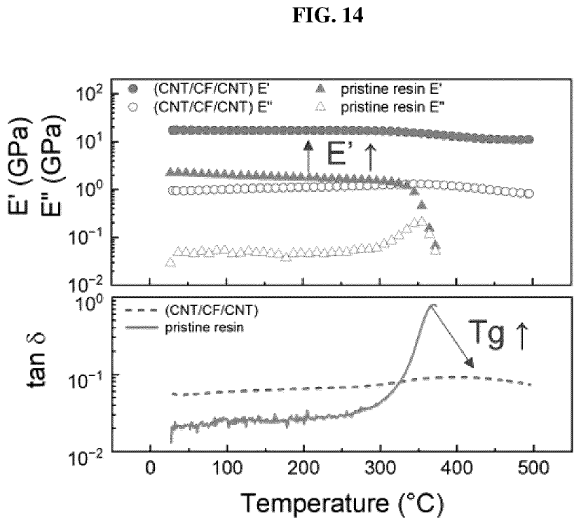

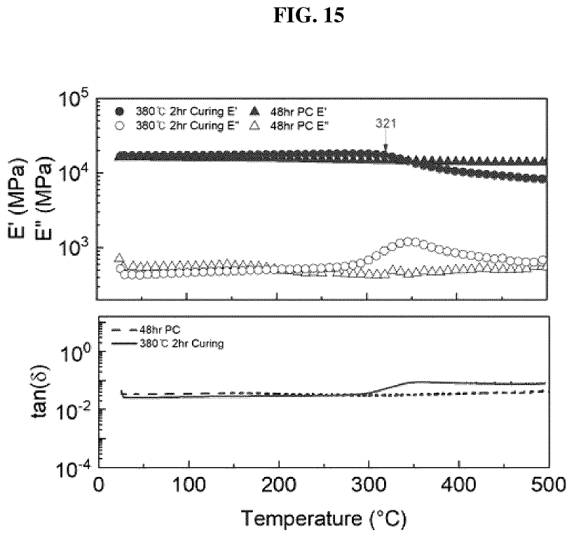

FIG. 14 shows a result of measuring the heat resistance of the hybrid composite having a stack structure in which the intermediate material layer; the carbon fiber layer; and the intermediate material layer are sequentially stacked on top of each other in this order. FIG. 15 shows a result of measuring the heat resistance based on a post-curing condition of a hybrid composite having the stack structure in which the intermediate material layer; the carbon fiber layer; and the intermediate material layer are sequentially stacked on top of each other in this order.

The storage modulus and the loss modulus are measured while holding the top and bottom of the film and shaking the film at a strain of 0.5% and a frequency of 1 Hz using a DMA (Dynamic Mechanical Analyzer). While the polyimide high-temperature resin (Oligo-PI) has a Tg around 350° C., the Tg of the hybrid composite has 410° C. and increases. When curing the composite, the final curing temperature is 380° C. for 2 hours. It is identified that when the composite is post-cured once more (at 450° C. for 48 hours), the composite exhibits high heat resistance such that Tg is not observed. In summary, it is identified that the Tg of the hybrid composite having the stack structure of the intermediate material layer; carbon fiber layer; and intermediate material layer (CNT/CF/CNT) increases by 20% (based on tan δ) compared to that of the pristine polymer, and at the same time, the storage modulus thereof increases due to CF and CNT. Further, it is identified that when the stack of the intermediate material layer; carbon fiber layer; and intermediate material layer is post-cured, the heat resistance of the composite is further improved.

### EXAMPLE 3

In Example 3, an alternative method of preparing a hybrid composite according to the present disclosure is disclosed. The descriptions of contents duplicate with the contents described above will be omitted.

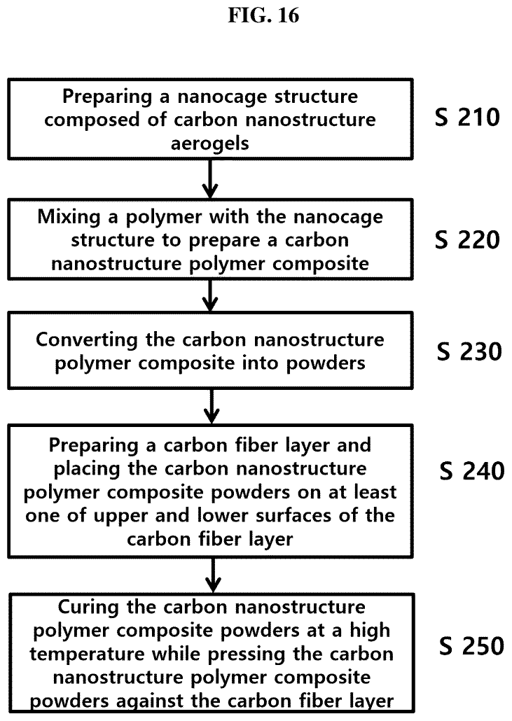

FIG. 16 illustrates a flow chart of a method of preparing a hybrid composite according to an additional embodiment of the present disclosure.

As illustrated in FIG. 16, the method of preparing a hybrid composite according to an additional embodiment of the present disclosure includes a step S210 of preparing a nanocage structure composed of carbon nanostructure aerogels; a step S220 of mixing a polymer with the nanocage structure to prepare a carbon nanostructure polymer composite; a step S230 of converting the carbon nanostructure polymer composite into powders; a step S240 of preparing a carbon fiber layer and placing the carbon nanostructure polymer composite powders on at least one of upper and lower surfaces of the carbon fiber layer; and a step S250 of curing the carbon nanostructure polymer composite powders at a high temperature while pressing the carbon nanostructure polymer composite powders against the carbon fiber layer.

In step S210, the nanocage structure composed of carbon nanostructure aerogels is prepared. In this regard, a solution in which carbon nanostructure is dissolved in a dispersing liquid is phase-changed into a gel state to prepare a nanocage structure composed of carbon nanostructure aerogels.

In accordance with the present disclosure, the dispersing liquid used to entirely disperse the carbon nanotubes (CNT) therein may be an anionic dispersant which may be selected from the group consisting of SDS (Sodium dodecyl sulfate), LDS (Lithium dodecyl sulfate), NaDDS (Sodium dodecylbenzene sulfonate), SDSA (Sodium dodecyl sulfonate), or SDBS (Sodium dodecylbenzenesulfonate) as alkyl sulfate-based anionic dispersant. Alternatively, the dispersing liquid used to entirely disperse the carbon nanotubes (CNT) therein may be a cationic dispersant which may be selected from the group consisting of CTAC (Cetyltrimethyl ammonium chloride), CTAB (Cetyltrimethyl ammonium bromide), or DTAB (Dodecyl-trimethyl ammonium bromide). Alternatively, the dispersing liquid used to entirely disperse the carbon nanotubes (CNT) therein may be a nonionic dispersant which may be selected from the group consisting of glycerol monostearate, sorbitan monooleate, Tween 80, PVA (Polyvinyl alcohol), PMA (Polymethyl acrylate), MC (Methyl cellulose), and CMC. (Carboxyl methyl cellulose), GA (Gum Arabic), Polysaccharide (Dextrin), PEI (Polyethylenimine), PVP (Polyvinylpyrrolidone) or PEO (Polyethylene oxide), and Poly(ethylene oxide)-Poly(butylene oxide) terpolymer.

When preparing a carbon aerogel precursor, a concentration of the carbon material dispersing liquid may be adjusted. In one example, the concentration of the carbon material dispersing liquid may be adjusted to a value in a range from 0.001 wt % to 30 wt %.

In preparing the carbon aerogel precursor according to the present disclosure, the concentration of the carbon material dispersing liquid may be adjusted such that a phase of the carbon material may be changed to a gel phase as an intermediate phase between a liquid phase and a solid phase. A continuous network structure between carbon nanomaterials may be formed, thereby securing mechanical and electrical properties of the finally prepared carbon aerogel precursor.

Furthermore, in preparing the carbon aerogel precursor according to the present disclosure, a binder may be added, and the binder may be freely used without limitation as long as it is a material that undergoes a phase transition from a solid phase to a liquid phase depending on the temperature.

The binder may be gelatin, cellulose, or chitosan. In the step for preparing the carbon aerogel precursor according to the present disclosure, the binder may be preferably gelatin, chitosan, or cellulose selected from the group consisting of methylcellulose, ethylcellulose, ethylmethylcellulose, hydroxyethyl cellulose, hydroxypropylcellulose, methylhydroxyethylcellulose, ethylhydroxyethylcellulose, hydroxypropylmethylcellulose, carboxymethylcellulose, and mixtures thereof. As long as a polymer exhibits UCST (upper critical solution temperature) behavior, it may be used as the binder without limitation thereto.

According to the present disclosure, a diameter of each of the inner pores of the carbon nanostructure aerogel may be in a range of 0.5 nm to 50 nm, preferably 0.5 nm to 20 nm. In accordance with the present disclosure, the nanocage structure may be composed of the carbon nanotube (CNT) aerogel instead of general carbon nanotube (CNT). The carbon nanotube (CNT) in a form of an aerogel has a pore size in a range of 0.5 nm to 50 nm, preferably 0.5 nm to 20 nm, thereby achieving a nanoconfinement effect in which movement of the polymer due to heat is suppressed while the polymer is trapped in the pores of the aerogel.

In one example, a content of the carbon nanotube (CNT) in the carbon nanotube (CNT) aerogel may be in a range of 0.01 wt % to 10 wt %, preferably 0.05 wt % to 10 wt %, relative to a total weight of the carbon nanotube (CNT) aerogel. When the content of the carbon nanotube (CNT) in the carbon nanotube (CNT) aerogel of the present disclosure is smaller than 0.01 wt % based on the total weight of the carbon nanotube (CNT) aerogel, the mobility of the polymer chain is not suppressed. When the content exceeds 10 wt % based on the total weight of the carbon nanotube (CNT) aerogel, the polymer resin is not impregnated into the aerogel during composite production.

The crosslinked polymer includes a thermosetting crosslinked polymer located in the inner pores of the nanocage structure, and includes at least one selected from the group consisting of epoxy resin, polyimide resin, cyanate resin, phenol resin, melamine resin, silicone resin, urea resin, and unsaturated polyester resin. The thermosetting resin exhibits stable mechanical properties at a temperature below a glass transition temperature after the crosslinking reaction. On the other hand, at a temperature higher than the glass transition temperature, polymer chain flow is activated, such that mechanical strength and stiffness decrease.

The thermosetting resin used in the present disclosure may include a material that has a viscosity and molecular weight controlled such that the material may be injected into the carbon nanotube aerogel before curing thereof, and may be crosslinked under heat or UV. The material may include epoxy resin, polyimide resin, epoxy resin, polyimide resin, epoxy resin, polyimide resin, cyanester resin, phenol resin, melamine resin, silicone resin, urea resin, and unsaturated polyester resin. For example, the thermosetting resin of the present disclosure may include a thermosetting polyimide (Oligo-P) modified with a reactive group at an end of an imide oligomer having a small molecular weight. The thermosetting polyimide (Oligo-P) modified with the reactive group at the end of the imide oligomer of the small molecular weight is characterized by having a size such that that the thermosetting polyimide modified with the reactive group at the end of the imide oligomer of the small molecular weight may be trapped in the pores of the carbon nanotube aerogel, and is characterized in that molecules chemically crosslink with each other through a subsequent thermosetting process, thereby having mechanical and thermal stability even at high temperatures.

A content of the crosslinked polymer may be in a range of 10 wt % to 90 wt %, preferably 20 wt % to 90 wt %, based on a total weight of the high heat-resistant carbon nanostructure polymer composite. When the content of the crosslinked polymer is smaller than 10 wt % based on a total weight of the high heat-resistant carbon nanostructure-polymer composite, there may be a problem that the mechanical properties of the composite are not sufficient. When the content exceeds 90 wt %, there may be a problem that the improvement in the glass transition temperature due to the nano-confinement effect cannot be expected.

In step S220, the polymer is mixed with the nanocage structure to prepare a carbon nanostructure polymer composite layer. In the step of mixing the polymer with the nanocage structure to prepare the carbon nanostructure polymer composite layer, the polymer may exist in a solid powder state at room temperature or may exist in a liquid state.

When the polymer exists in a solid powder state at room temperature, the carbon nanostructure dispersion and the polymer powders are mixed with each other to produce an aerogel in which the polymer powders are evenly distributed isotropically within the carbon nanostructure network. The aerogel is heated so that the polymer particles melt and are evenly distributed within the carbon nanostructure network.

It is important to create a state in which the CNTs (carbon nanotubes) are well dispersed in a state in which strands thereof are spaced from each other. For this purpose, a well-dispersed CNT dispersion is used, and the resin powders are mixed into the well-dispersed CNT dispersion. As a result, the resin particles are evenly distributed within the CNT network (nano-cage). In this state, the polymer is impregnated therein to create a CNT+polymer intermediate (aerogel). The CNT+polymer aerogel is heated to a temperature so that the resin particles (polymer particles) melt and are evenly distributed on the surface of the CNT. When the resin melts, the resin is evenly distributed within the CNT network. The intermediate material as created in this way may be used in a form of a film or may be ground.

When the polymer exists in a liquid state at room temperature, the polymer is melted and impregnated into the carbon nanostructure aerogel to create the carbon nanostructure polymer composite layer.

In step S230, the carbon nanostructure polymer composite is converted into powders. The carbon nanostructure polymer composite prepared in step S220 is pulverized into the powders.

In step S240, the carbon fiber layer is prepared and then, the carbon nanostructure polymer composite powders are placed on at least one of the upper or lower surface of the carbon fiber layer. In this case, the carbon nanostructure polymer composite powders may be placed on either the upper or lower surface of the carbon fiber layer, or on both surfaces thereof. The carbon fiber layer includes not only carbon fibers but also a carbon fiber composite into which the carbon fibers and the polymer are composited into.

In step S250, while the carbon nanostructure polymer composite powders are pressed against the carbon fiber layer, the carbon nanostructure polymer composite powders are cured at a high temperature. Thus, when the carbon nanostructure polymer composite powders have been pressed against the carbon fiber layer, the carbon nanostructure is impregnated into between the carbon fibers.

The hybrid composite of the present disclosure prepared in this manner includes a carbon nanostructure polymer composite including: a nanocage structure composed of carbon nanostructure aerogels; and thermosetting crosslinked polymer located in inner pores of the nanocage structure; and carbon fiber tows or carbon fiber layers, wherein the carbon nanostructure polymer composite is disposed in a space between the carbon fiber tows or in a space between the carbon fibers layers.

In Example 3, the intermediate material is prepared by impregnating the nanocage structure (preform) with the polymer. The carbon nanotubes (CNT) are used as the nanocage structures, and polyimide is used as the polymer. 10 wt % of nanocage and 90 wt % of polymer are mixed with each other and the mixture is subjected to heat treatment at 280° C. for 1 hour to prepare the intermediate material. Then, the intermediate material is pulverized to prepare the nanocage intermediate material powders (NCP).

Using the NCPs, the hybrid composite (CFRP: Carbon Fiber Reinforced Polymer) as a nanocage-based carbon fiber polymer composite is prepared.

Specifically, the nanocage intermediate material powders are applied on the top and the bottom of the layer of the carbon fibers such as NCP/CF/NCP, and then are pressed and cured at the high temperature. Specifically, under 20 MPa, first curing is performed at 300° C. for 15 hours, an additional post-curing is performed at 420° C. for 24 hours. In the hybrid composite as prepared in this way, the nanocage (NC) and the polymer are evenly impregnated into between CFs and CF.

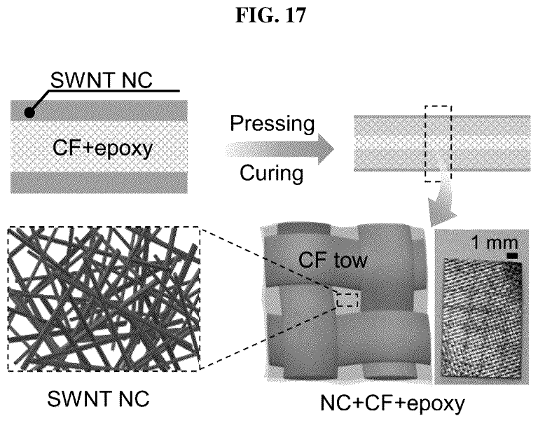

FIG. 17 shows a schematic diagram of a preparing process of the nanocage carbon fiber hybrid composite according to an additional embodiment of the present disclosure.

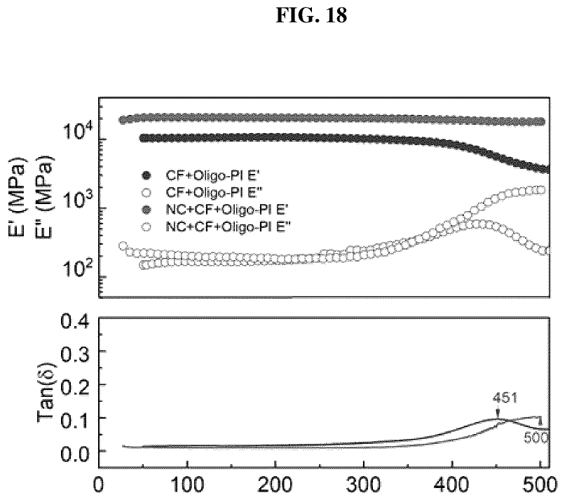

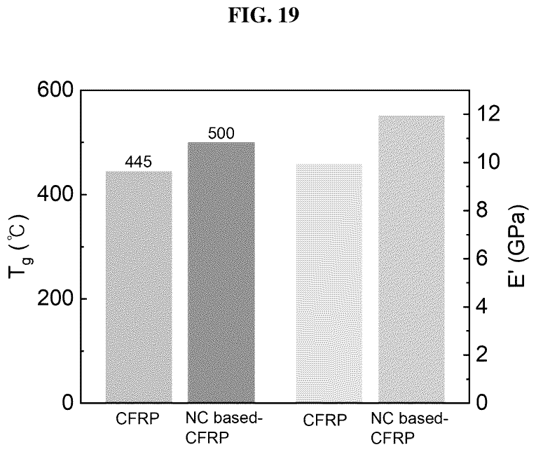

FIG. 18 shows the heat resistance data of the prepared nanocage carbon fiber hybrid composite. FIG. 19 shows improvement in the mechanical property of the prepared nanocage carbon fiber hybrid composite.

As shown in FIG. 18, the CFRP (Carbon Fiber Reinforced Polymer) composed of CF+oligo-PI has a structure in which 10 CF sheets are stacked, whereas the NC+CF+oligo-PI hybrid composite containing NC has a structure in which only 2 CF sheets are stacked. However, the storage modulus of the hybrid composite is higher than that of the general CFRP composed of the 10 CF sheets. This is because the NC plays a role in imparting the additional stiffness. Further, this is because NCs are present in a well-dispersed state within the composite. Furthermore, the hybrid composite exhibits no decrease in E′ (storage modulus) until the temperature reaches 500 degrees C., thus indicating that mechanical properties thereof are maintained even at high temperatures. As shown in FIG. 19, it is identified that the hybrid composite has a Tg (glass transition temperature) that is higher by 50 degrees Celsius than that of the general CFRP and has a higher E′ value (storage modulus) than that of the general CFRP. This means that the hybrid composite may provide excellent thermal stability and mechanical stiffness, and may play an important role in maintaining performance especially in high-temperature environments.

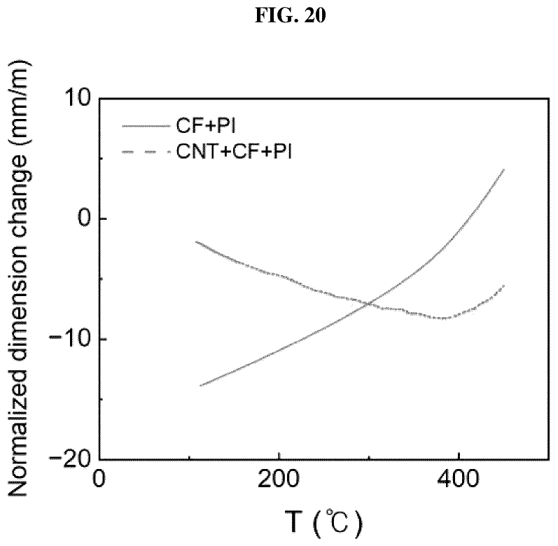

FIG. 20 shows the dimensional change based on a temperature change of the nanocage carbon fiber hybrid composite. Based on a result of comparing the thermal behavior of the general CFRP composed of CF+PI and the thermal behavior of the hybrid composite composed of CNT+CF+PI with each other, it is identified that there is a large difference between the dimensional changes in the thickness direction of the two composites during the cooling process from 450° C. to 150° C. The general CFRP exhibits a dimensional change of 15.2 mm/m, while the hybrid composite exhibits a dimensional change of 6.4 mm/m as one half thereof and thus exhibits greater thermal stability. This is because cracks may occur due to the difference between thermal expansion rates (CTE) of the CF and the polymer during the cooling process after curing the general CFRP composite, while the hybrid composite includes nanocages (NC) that can reduce the thermal expansion instead of the polymer, and thus exhibits a low thermal expansion rate similar to that of CF. Therefore, in the hybrid composite, the cracks hardly occurred during the cooling process, so that a more stable structure could be maintained. To summarize the above descriptions, during the curing, significant shrinkage occurs due to the difference between coefficients of thermal expansion between the general resin and the CF, such that the cracks occur therein. However, in the CNT+CF+PI composite, the difference between coefficients of thermal expansion may be reduced due to the CNT, so that no significant dimensional change is observed. When CNTs are present between the CF layers and/or between of CF tows, the coefficient of thermal expansion (CTE) of the resin is reduced, thereby reducing the difference between thermal expansions of the CF and the polymer (resin), and accordingly, occurrence of internal cracks or distortion occurring during the cooling process after curing may be reduced, thereby allowing for the production of a more sound and stable composite. In this regard, an interlayer space refers to a space between individual carbon fiber layers in a composite structure composed of multiple layers. The carbon fiber-reinforced composite may be formed by stacking multiple layers of carbon fibers. When CNTs are distributed between these layers, they are being referred to as being located in the interlayer space. In this regard, the CNTs present between the CF layers may improve the adhesion (interlayer strength) between the CF layers, and may play an important role in improving the mechanical and electrical performance of the composite. The CF tow refers to a structure in which several individual carbon fiber filaments are gathered together to form a bundle (tow). In this regard, CF is usually used in this tow form. When the CNTs are present between the CF tows, this means that the CNTs are present in the space between the carbon fiber tows. In a structure in which several CF tows are stacked on top of each other, the CNTs are located in the gap or space between adjacent ones of the CF tows. In this regard, the CNTs may improve the overall performance of the composite by enhancing the bonding strength and electrical connectivity between the CF tows.

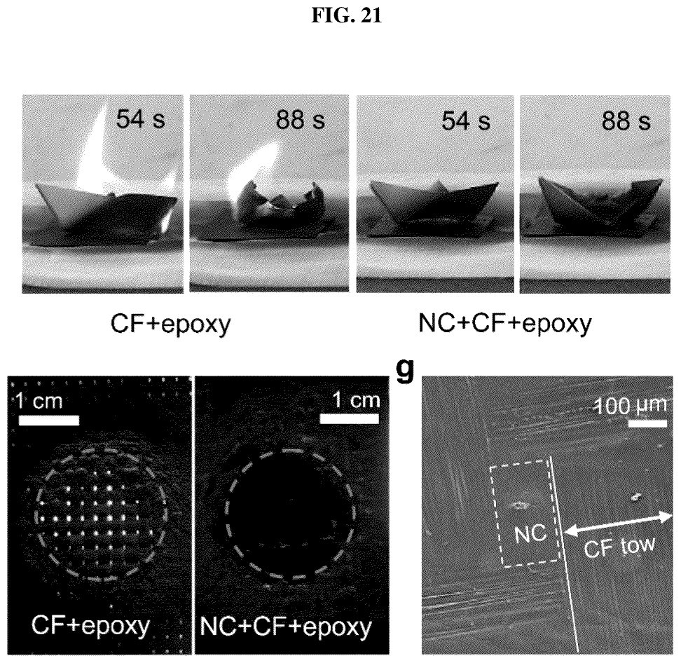

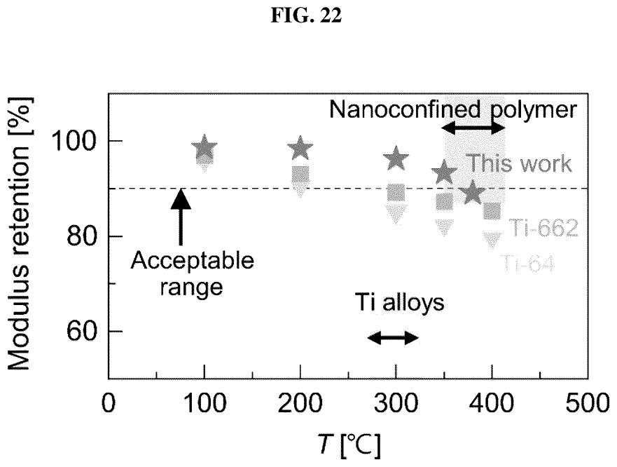

FIG. 21 is an experimental diagram of the flame retardancy characteristics of the nanocage carbon fiber hybrid composite. FIG. 22 is a comparative diagram of the thermal stability data of the nanocage carbon fiber hybrid composite. It is identified that the hybrid composite has excellent flame retardancy characteristics and excellent thermomechanical properties compared to the general CFRP. In the general CFRP, the polymer between the CFs is vulnerable to flame, thereby causing holes such that flames rise upwardly, whereas in the hybrid composite, the nanocages (NCs) are distributed between the CF tows and on the surface of the CF two, so that holes are not formed due to the flames, and thus the flames are effectively prevented from rising upwardly to the paper boat. Furthermore, the hybrid composite maintained heat resistance because the NCs remained intact between the CFs after exposure to flame. Furthermore, in the comparison between the mechanical properties of the titanium alloy and the hybrid composite, the modulus retention rate of the titanium alloy drops to a value below 90% starting from 300° C., while the hybrid composite exhibits a modulus retention of over 90% up to 370° C., indicating that it may maintain excellent performance even at higher temperatures.

In summary, the nanocage-micro carbon fiber composite exhibits a more delayed combustion characteristic compared to the CF+epoxy free of the nanocage. It is identified through SEM analysis that after the combustion, the sample with the nanocage does not have any voids, and the nanocage still exists between the CF layers. Furthermore, it is identified under the comparison of the modulus retention based on the temperature that the modulus of the Ti alloy decreases rapidly starting from 300° C., while the nanocage-micro carbon fiber composite exhibits a modulus retention of more than 90% up to 400° C. It is identified that the composite having the nanocage is lighter than the Ti alloy and has a higher working temperature range (380 to 420° C.) than that of the Ti alloy, thereby exhibiting the superior thermal performance compared to the metal alloy.

Although the embodiments of the present disclosure have been described above with reference to the accompanying drawings, the present disclosure may not be limited to the embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that the embodiments as described above are not restrictive but illustrative in all respects.

What is claimed is:

1. A high heat-resistant carbon nanostructure polymer composite comprising:
a nanocage structure composed of carbon nanostructure aerogels; and
a thermosetting crosslinked polymer positioned in inner pores of the nanocage structure.

2. The high heat-resistant carbon nanostructure polymer composite of claim 1, wherein a minimum length by which the polymer positioned in the inner pores of the nanocage structure can move under a glass transition temperature is smaller than a minimum length by which the polymer itself can move under the glass transition temperature, such that a following Equation 1 is satisfied:
$$ζ < {ζ}_{Bulk polymer} \qquad [ Equation 1 ]$$
where ζ denotes a minimum length by which a thermosetting resin can move in the composite under the glass transition temperature or a size of a space in the nanocage structure where the crosslinked polymer is able to be present, and ζ_{Bulk polymer} denotes a minimum length by which the crosslinked polymer itself can move under the glass transition temperature.

3. The high heat-resistant carbon nanostructure polymer composite of claim 1, wherein a correlation between a distance between the carbon nanostructure aerogels in a polymer matrix and a volume fraction of the carbon nanostructure aerogel in the high heat-resistant carbon nanostructure polymer composite is expressed based on a following Equation 2:
$$\frac{Δ}{R} = \sqrt{\frac{{V}_{f , max}}{{V}_{f}}} - 1 \qquad [ Equation 2 ]$$
wherein in the Equation 2, 2Δ denotes a distance between nanotubes in the carbon nanostructure aerogel, R denotes a radius of each of the nanotubes constituting the carbon nanostructure aerogel, V_{f,max} denotes a maximum volume fraction of the carbon nanostructure aerogel, and V_{f} denotes a volume fraction of the carbon nanostructure aerogel.

4. The high heat-resistant carbon nanostructure polymer composite of claim 3, wherein a content of the carbon nanostructure aerogel in the high heat-resistant carbon nanostructure polymer composite is 10 vol % or greater.

5. The high heat-resistant carbon nanostructure polymer composite of claim 3, wherein a content of the carbon nanostructure aerogel in the high heat-resistant carbon nanostructure polymer composite is 20 vol % or greater.

6. The high heat-resistant carbon nanostructure polymer composite of claim 3, wherein a content of the carbon nanostructure aerogel in the high heat-resistant carbon nanostructure polymer composite is 30 vol % or greater.

7. The high heat-resistant carbon nanostructure polymer composite of claim 1, wherein the carbon nanostructure includes at least one selected from a group of carbon materials consisting of carbon nanotube (CNT), graphene, graphene oxide, carbon black, carbon nanofiber, and graphite.

8. The high heat-resistant carbon nanostructure polymer composite of claim 1, wherein the thermosetting crosslinked polymer includes at least one selected from a group consisting of epoxy resin, polyimide resin, cyanate resin, phenol resin, melamine resin, silicone resin, urea resin, and unsaturated polyester resin.

9. A method for preparing a hybrid composite, the method comprising:
preparing a nanocage structure composed of carbon nanostructure aerogels;
mixing a polymer with the nanocage structure to prepare a carbon nanostructure polymer composite layer;
stacking the carbon nanostructure polymer composite layer and a polymer layer to prepare an intermediate material layer;
providing a carbon fiber layer and stacking the intermediate material layer and the carbon fiber layer on top of each other to form a stack of the intermediate material layer and the carbon fiber layer; and
pressing the stack in a mold at a high temperature.

10. The method for preparing the hybrid composite of claim 9, wherein the preparing of the nanocage structure composed of the carbon nanostructure aerogels includes preparing a solution in which carbon nanostructures are dissolved in a dispersing liquid, and changing a phase of the prepared solution into a gel state, thereby preparing the nanocage structure composed of the carbon nanostructure aerogels.

11. The method for preparing the hybrid composite of claim 9, wherein in the mixing of the polymer with the nanocage structure to prepare the carbon nanostructure polymer composite layer, the polymer exists in a solid powder state at room temperature,
wherein the mixing of the polymer with the nanocage structure to prepare the carbon nanostructure polymer composite layer includes:
mixing a carbon nanostructure dispersion and the polymer powders with each other to produce an aerogel in which the polymer powders are evenly distributed isotropically within a carbon nanostructure network; and
heating the aerogel so that the polymer particles melt and are evenly distributed within the carbon nanostructure network.

12. The method for preparing the hybrid composite of claim 9, wherein in the mixing of the polymer with the nanocage structure to prepare the carbon nanostructure polymer composite layer, the polymer exists in a liquid state at room temperature,
wherein the mixing of the polymer with the nanocage structure to prepare the carbon nanostructure polymer composite layer includes impregnating the carbon nanostructure aerogel with the polymer.

13. The method for preparing the hybrid composite of claim 9, wherein the stack is pressed in the mold at the high temperature such that the carbon nanostructure is impregnated into between carbon fibers of the carbon fiber layer.

14. The method for preparing the hybrid composite of claim 9, wherein the method further comprises curing the stack after the pressing of the stack in the mold at a high temperature,
wherein the curing includes first curing at 380° C. for 2 hours, and second-curing at 450° C. for 48 hours.

15. A method for preparing a hybrid composite, the method comprising:
preparing a nanocage structure composed of carbon nanostructure aerogels;
mixing a polymer with the nanocage structure to prepare a carbon nanostructure polymer composite;
converting the carbon nanostructure polymer composite into powders;
preparing a carbon fiber layer;
placing the carbon nanostructure polymer composite powders on at least one of upper and lower surfaces of the carbon fiber layer; and
curing the carbon nanostructure polymer composite powders at a high temperature while pressing the carbon nanostructure polymer composite powders against the carbon fiber layer.

16. The method for preparing the hybrid composite of claim 15, wherein the preparing of the nanocage structure composed of the carbon nanostructure aerogels includes preparing a solution in which carbon nanostructures are dissolved in a dispersing liquid, and changing a phase of the prepared solution into a gel state, thereby preparing the nanocage structure composed of the carbon nanostructure aerogels.

17. The method for preparing the hybrid composite of claim 15, wherein in the mixing of the polymer with the nanocage structure to prepare the carbon nanostructure polymer composite layer, the polymer exists in a solid powder state at room temperature,
wherein the mixing of the polymer with the nanocage structure to prepare the carbon nanostructure polymer composite layer includes:
mixing a carbon nanostructure dispersion and the polymer powders with each other to produce an aerogel in which the polymer powders are evenly distributed isotropically within a carbon nanostructure network; and
heating the aerogel so that the polymer particles melt and are evenly distributed within the carbon nanostructure network.

18. The method for preparing the hybrid composite of claim 15, wherein in the mixing of the polymer with the nanocage structure to prepare the carbon nanostructure polymer composite layer, the polymer exists in a liquid state at room temperature,
wherein the mixing of the polymer with the nanocage structure to prepare the carbon nanostructure polymer composite layer includes impregnating the carbon nanostructure aerogel with the polymer.

19. The method for preparing the hybrid composite of claim 15, wherein the carbon nanostructure polymer composite powders are pressed against the carbon fiber layer such that the carbon nanostructure is impregnated into between carbon fibers of the carbon fiber layer.

20. A hybrid composite comprising:
a carbon nanostructure polymer composite including:
a nanocage structure composed of carbon nanostructure aerogels; and
thermosetting crosslinked polymer located in inner pores of the nanocage structure; and
carbon fiber tows or carbon fiber layers, wherein the carbon nanostructure polymer composite is disposed in a space between the carbon fiber tows or in a space between the carbon fibers layers.

21. The hybrid composite of claim 20, wherein the carbon fiber includes a carbon fiber composite.
